(19) United States
(12) Patent Application Publication
(10) Pub. No.: US 2005/0064939 A1
(43) Pub. Date: Mar. 24, 2005

(54) Electronic mail gaming system

(76) Inventors: Brendan T. McSheffrey, Newton, MA (US); Kevin Gulley, Newton, MA (US)

Correspondence Address: FISH & RICHARDSON PC, 225 FRANKLIN ST, BOSTON, MA, 02110, US

(21) Appl. No.: 10/664,651

(22) Filed: Sep. 19, 2003

(51) Int. Cl. G06F 19/00

(52) U.S. Cl. 463/42

(57) ABSTRACT

A computer-implemented method for managing distribution of games includes: receiving an E-mail game on a server located at a server site, storing the received E-mail game at the server site with another previously stored E-mail game, providing access to the E-mail games for retrieval, and sending the first E-mail game, if requested by a player, to a game player site for initiating an instance of the E-mail game.

### TECHNICAL FIELD

This invention relates to electronic mail (E-mail) gaming systems, and, more particularly, to an E-mail gaming system for managing the publishing, distributing, and playing of multiple E-mail game titles.

### BACKGROUND

Multi-player games in which players are remotely located relative to each other considerably antedates computers and computer gaming technology. For example, a form of chess, known as correspondence chess has been and continues to be quite popular. In correspondence chess, each player maintains his or her own chessboard containing the current status of the game. A player takes a turn by moving a piece on their chessboard, writing a letter to their opponent in which their move is set forth and mailing the letter containing the move to the opponent. When the opponent receives the correspondence containing the new move, the opponent updates his or her own chessboard, makes a countering move, and repeats the process. Correspondence chess tends to be a leisurely and thoughtful game, owing in part to the long delays introduced by the delivery of game moves by postal service.

With the introduction of computer systems and the Internet, correspondence games can be played using E-mail, rather than postal mail. Generally, the game is played in the same manner as described above in connection with postal correspondence gaming. However, by utilizing E-mail, the long delay introduced by the delivery of postal mail is significantly reduced. Furthermore, by assigning unique E-mail addresses to different people, players can play multiple games with multiple opponents.

### SUMMARY

According to one aspect of the invention, a computer-implemented method for managing distribution of games includes: receiving a first E-mail game on a server located at a server site, storing the received first E-mail game at the server site with a previously stored second E-mail game, providing access to the first and second E-mail games for retrieval, and sending the first E-mail game, if requested by a first player, to a first game player site for initiating an instance of the first E-mail game.

Preferred embodiments of this aspect of the invention may include one or more of the following additional features. The computer-implemented method may further include receiving a file on the server from the first game player site, the file may include data representing a first game move associated with an initiated instance of the first E-mail game, producing an E-mail message that may include data representing the first game move applied to the initiated instance of the first E-mail game, and transmitting the E-mail message to a second game player site to initiate a second game move of the initiated instance of the first E-mail game by a second player. The first E-mail game may be received from an E-mail game developer site. The first and second E-mail games may be stored on a storage device storing multiple E-mail games. The file may use hypertext transfer protocol (HTTP). The file may include extensible markup language (XML). The file may include a message from the first player for delivery to the second player. The file may identify the second player. The computer-implemented method may further include, storing the first game move applied to the initiated instance of the first E-mail game on a storage device that may be in communication with the server. The E-mail message may include an invitation for the second player to participate in the initiated instance of the first E-mail game. The E-mail message may include an advertisement for displaying to the second player. The E-mail message may include the state of the initiated instance of the first E-mail game. The first E-mail game may be a turn-based E-mail game. The first game move applied to the initiated instance of the first E-mail game may be displayed at the second game player site based on receipt of the E-mail message. The computer-implemented method further include receiving a file on the server from the first game player site, the file may include data representing a first game move associated with an initiated instance of the first E-mail game, producing an E-mail message that may include data representing the server being ready to transmit an HTTP file that may include data representing the first game move applied to the initiated instance of the first E-mail game, and transmitting the E-mail message to a second game player site to initiate a second game move of the initiated instance of the first E-mail game by a second player.

The invention thus provides a computer-implemented method for collecting, publishing, and managing multiple types of E-mail games stored at a server site. By publishing multiple downloadable E-mail games to a potential player, the player can select from the published games and download one or more games for executing at the player's location. In addition to providing access to multiple E-mail game titles, the server site also manages each game instance being played by receiving game moves associated with a game instance, applying the game moves to the current state of the respective game instance, and requesting that an opponent send the next game move to the server. Furthermore, by storing the current state of each game instance at the server site, each instance can be restored at a player's location in the event of a malfunction of the player's computer system or other similar event.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram depicting a system for publishing and managing multiple types of E-mail games.

FIG. 2 is a graphical user interface displaying an instance of an E-mail game.

FIG. 3 is a graphical user interface displaying a message window.

FIG. 4 is a flow chart of an E-mail game upload process.

FIG. 5 is a flow chart of a receive HTTP file process.

FIG. 6 is a flow chart of an E-mail game management process.

FIG. 7 is a flow chart of an E-mail message transmission process.

### DETAILED DESCRIPTION

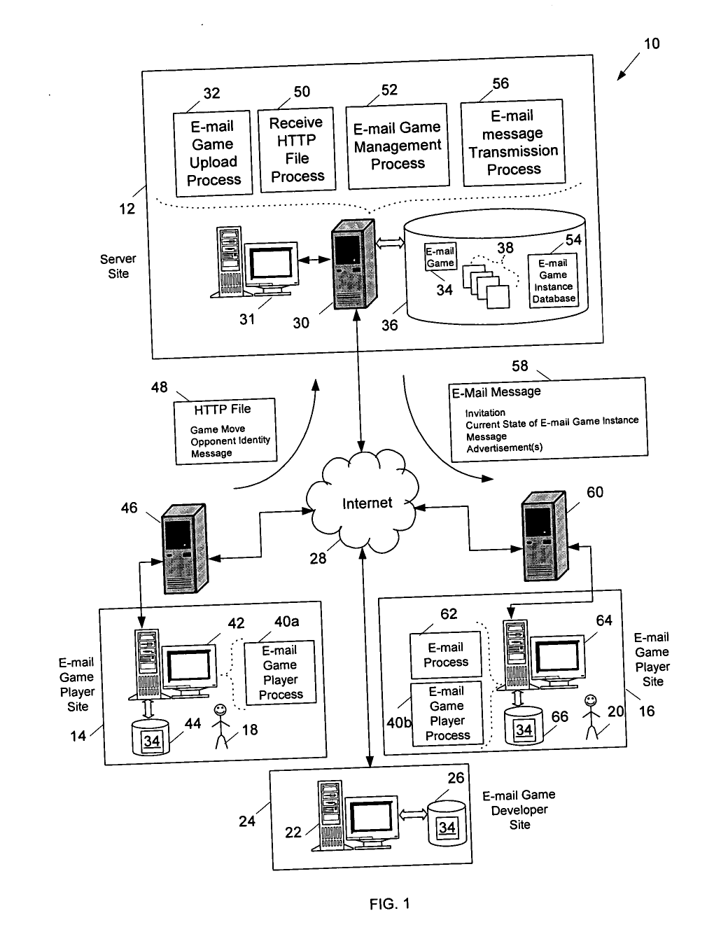

Referring to FIG. 1, in one embodiment, a system 10 for publishing and managing multiple E-mail games includes a server site 12 that typically includes one or more computer systems, servers, etc. that provide access to and management of the E-mail games offered to potential players that are typically located at separate remote sites. In this example, the server site 12 is managing an instance of an E-mail game being played between players respectively located at two player sites 14, 16. In general, server site 12 stores multiple types of E-mail games that can be selected by either player and downloaded for execution at the respective player site. For example, server site 12 is capable of providing and managing “turn-based” E-mail games (e.g., chess, checkers, tic-tac-toe, etc.) in which two or more players alternate in making game moves. The server site 12 is also capable of providing and managing “point-race” E-mail games (e.g., golf, bowling, etc.) in which two or more players race to reach a predetermined point amount or race to attain the most points during a specific time period. Types of E-mail games that use information collected from one or more resources may also be provided and managed by the server site 12. For example, the server site 12 is capable of collecting statistics associated with daily sporting events (e.g., baseball games, football games, etc.) and processing the statistics for use in rotisserie E-mail games (e.g., rotisserie baseball, etc.) that are provided and managed by the server site.

In this embodiment, to initiate an instance of an E-mail game provided by the server site 12, a player 18 located at player site 14 selects one of the multiple types of E-mail games available from the server site 12, downloads the game, and initiates an instance of the game for playing with a player 20 located at player site 16. By providing a selection of multiple types of E-mail games, players do not spend time searching multiple server sites, or other E-mail game depositories to find and select one or more E-mail games. Additionally, by managing the E-mail games from a single server site, as currently available E-mail games are updated or as new E-mail games are developed, the updated and new E-mail games can be uploaded to the server site 12 for storing, publishing, and managing.

In this embodiment, after a new E-mail game 34 is developed on a computer system 22 located at a developer site 24 (e.g., a software corporation, private software developer, etc.), the E-mail game is uploaded from a storage device 26 (e.g., a hard drive, CD-ROM, etc.) to the server site 12 through the Internet 28 which provides a communication link between the developer site and the server site 12. Typically, the E-mail game 34 is uploaded by transmitting one or more files from the computer system 22 to a server 30 that is located at the server site 12 and is executing an E-mail game upload process 32 that receives and stores the one or more files associated with the E-mail game 34 at the server site 12 with other types of E-mail games that are available for selection. In this particular embodiment the E-mail game upload process 32 receives a copy of the E-mail game 34 from the developer site 24 and stores the uploaded E-mail game on a storage device 36 (e.g., a hard drive, CD-ROM, etc.) that stores files associated with other versions or types of E-mail games 38. However, in some embodiments the E-mail game upload process 32 may store the received E-mail game 34 on a shared storage device with the use of a storage area network (SAN) or other relatively high-speed network for backup and archival storage of the E-mail games. By providing the capability of uploading E-mail games from various development sites, the server site 12 can encourage and solicit the development of updated or new E-mail games from various development sites. To encourage game development, in some embodiments, one or more websites or webpages are maintained by a computer system 31 located at the server site 12 so that potential developers can study the services provided along with the contractual terms associated with uploading an E-mail game to the server site.

In this particular embodiment, one or more websites or webpages associated with the server site 12 also provides potential players with a selection of the downloadable E-mail games that are available for initiating one or more game instances. Typically, to initiate a game instance between players, one or both of the players subscribes to the services provided by the server site 12. In this particular example, the player 18 located at player site 14 may access a website associated with the server site 12 via the Internet 28 and subscribes to the server site to gain access to the E-mail games 34, 38 stored in the storage device 36. In some embodiments, subscribing may be accomplished by the player 18 providing information (e.g., name, address, billing information, etc.) to the server site 12 by using the website.

Upon being given a subscription to the services available from the server site 12, in this embodiment, a copy of an E-mail game player process 40a is downloaded from the server site 12 to the player site 14. Typically the E-mail game player process 40a is executed on a computer system 42 located at the player site 14 and is usually stored locally on a storage device 44 (e.g., a hard drive, CD-ROM, etc.) in communication with the computer system. Also, in some embodiments, one or more E-mail games may be downloaded with the game player process 40a so that game instances can be immediately initiated by the E-mail game player process. Typically, the one or more E-mail games downloaded with the game player process are well-know game titles (e.g., chess, checkers, etc.) so that the players can focus on learning how to use the E-mail game player process 40a rather than spending time learning rules associated with the games. In this particular example, the E-mail game 34 is downloaded from the server site 12 to the player site 14 and stored on the storage device 44. Additionally, in this particular embodiment, to protect resources (e.g., computer system 42, storage device 44, etc.) located at player site 14, the E-mail game player process 40a, the E-mail game file 34, and other downloaded files and data transmitted between the player site 14 and the Internet 28 pass through a gateway server 46 that provides, for example, firewall protection.

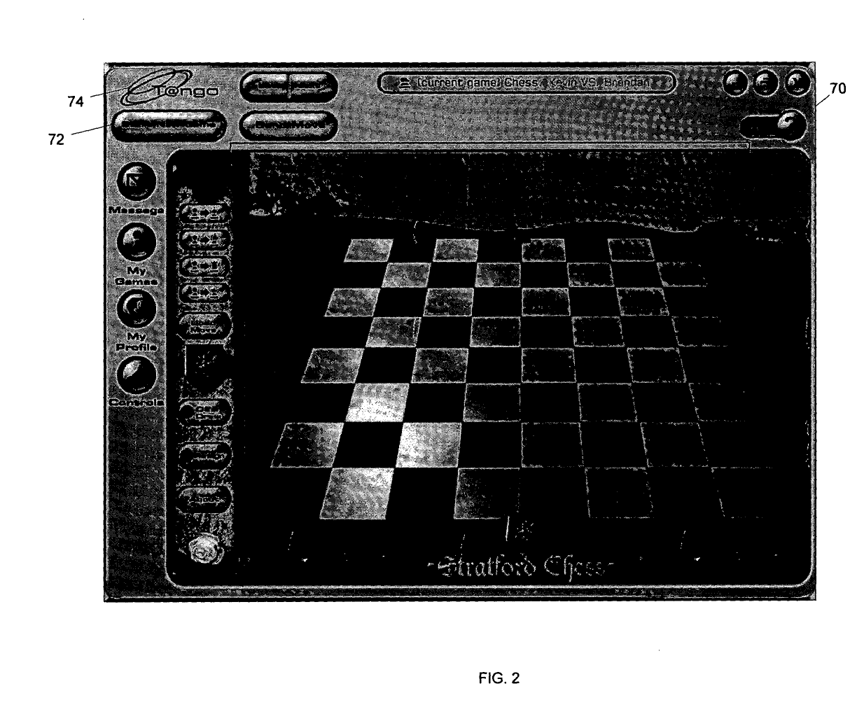

Referring to FIG. 2, after the E-mail game player process 40a and E-mail game file 34 are downloaded to the player site 14, the game player process can be executed by the computer system 42 to initiate an instance of an E-mail game. In this particular example, by executing the E-mail game player process 40a, a graphical user interface 70 (GUI) is presented on a screen of the computer system 42. To initiate an instance of the E-mail game 34, which in this example is a chess game, the player 18 selects a “Start New Game” button 72 included in the GUI 70 with a pointing device (e.g., a mouse) or keyboard included with the computer system 42. Alternatively, if the player 18 wants to initiate an instance of an E-mail game (e.g., a new game, an updated game, etc.) not currently stored at the player site 14, the player selects an icon 74 also included in the GUI 70 to present a website associated with the server site 12 so that the player can select from the multiple E-mail game titles available for downloading. In some embodiments by selecting the icon 74, here labeled “T@ngo”, a web browser (e.g., Microsoft Explorer™, Netscape Navigator™, etc.) is executed by the computer system 42 and a link is established with the associated website (e.g., www.tango.com) to display the E-mail game titles that are available and downloadable from the server site 12. After selecting and downloading one or more new games, the player 18 can then select the “Start New Game” button 72 to initiate an instance of one of the newly downloaded game.

Returning to FIG. 1, after an instance of an E-mail game is executed on the E-mail game player process 40a, information is entered by the player 18 into the computer system 42 to identify an opponent (e.g., player 20) for the game instance. For example, to identify the player 20 located at player site 16, an E-mail address of the player 20 is entered into the computer system 42. Typically, along with entering information to identify an opponent, the player 18 that initiated the game instance enters an initial game move into the computer system 42. For example, an initial game move may be entered into the GUI 70 (shown in FIG. 2) by selecting and moving a game piece. However, in some embodiments, the initial game move may be entered through the keyboard or other similar input device included in the computer system 42.

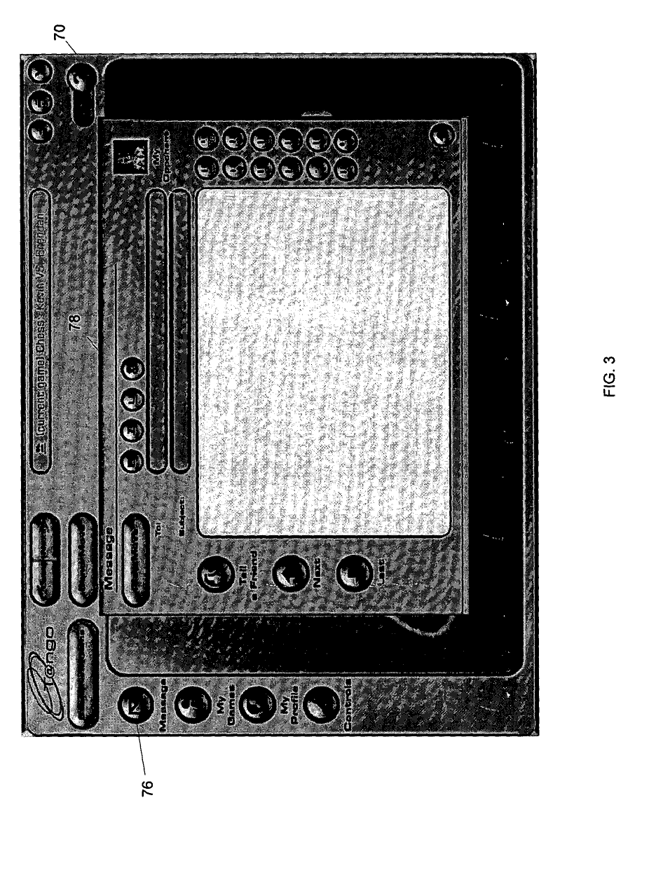

Referring to FIG. 3, along with entering an initial game move, in some embodiments, to encourage the player 20 to be an opponent in the E-mail game instance, a message may be entered into the GUI 70 by player 18 for delivery to the player 20. To produce a message for delivery to the potential opponent, the player 18 selects a “Write Message” button 76 included in the GUI 70 and a message window 78 is presented that allows entering of a text message. However, in some embodiments audio content, collected by a microphone in communication with the computer system 42, or video content, collected by a video camera in communication with the computer system, may be included individually or in combination with or without a text message.

Returning to FIG. 1, after the player 18 has initiated an E-mail game instance, entered a game move, identified an opponent, and optionally entered a message, for example, to encourage the identified opponent to enter the game, the E-mail game player process 40a produces a file 48 that contains data representing the game move, opponent identity, and the optional message of encouragement. In some embodiments the file 48 uses a protocol such as hypertext transfer protocol (HTTP) that provides a set of rules for transferring data (e.g., text, graphic images, sound, video, and other multimedia data) included in the file through the Internet 28. Also, in some embodiments, the HTTP file 48 may include markup symbols such as used in extensible markup language (XML), hypertext markup language (HTML), or other similar languages to describe the information included in the file. For example, wireless markup language (WML), which is based on XML, may be used in specifying content and user interfaces for narrowband devices, including cellular phones and pagers, which may be used in place of one or both of the computer systems 42, 64. After the HTTP file 48 is produced, the E-mail game player process 40a initiates the transmission of the file from the computer system 42, through the Internet 28, for delivery at the server site 12. In this particular embodiment, a single HTTP file 48 is transmitted to the server site 12, however, in other embodiments, two or more files may be used to transmit the information (e.g., game move, opponent identification, etc.) from the player site 14 to the server site.

Upon receiving the HTTP file 48 at the server site 12, a receive HTTP file process 50, which executes on the server 30, examines and processes the contents of the received file. In this embodiment, the receive HTTP file process 50 determines if the information included in the HTTP file 48 is providing a game move for initiating a new E-mail game instance or whether the information is providing a game move associated with a previously initiated game instance. Once the receive file process 50 examines the HTTP file 48, an E-mail game management process 52, also executing on the server 30, applies the game move included in the file to the appropriate E-mail game instance. If, for example, the HTTP file 48 includes an initial game move, a new instance of the E-mail game is produced, the initial game move is applied to the newly produced game instance, and the state of the game instance is stored at the server site 12. Alternatively, if the received game move is associated with a previously initiated E-mail game instance, the state of the game instance is retrieved from a storage device, such as storage device 36, then the game move is applied to the game instance and the updated state of the game instance is stored on the storage device. In this particular embodiment the state of each initiated E-mail game instance is stored in an E-mail game instance database 54 that is stored on the storage device 36. However, in other embodiments, the state of each E-mail game instance may be stored in multiple databases, or other types of data files, which may or may not be located at the server site 12. Once the game move from the HTTP file 48 has been used to initiate a new game instance or applied to a previously initiated game instance, the state of the game instance with the game move applied is received by an E-mail message transmission process 56 for inclusion in an E-mail message 58 that is sent to the opponent of the previously initiated game instance or to a potential opponent (e.g., player 20) of the newly initiated game instance.

Typically, in producing the E-mail message 58, the E-mail message transmission process 56 collects information from the HTTP file 48, the server site 12, and other resources (e.g., a websites, webpages, etc.). For example, the E-mail message transmission process 56 collects the current state of an E-mail game instance from the server site 12 for including in the E-mail message 58. The E-mail message transmission process 56 may also collect, for example, previously executed game moves for inclusion in the E-mail message 58 so that the player 20 can study the game move progression that caused the current state of the game instance. Upon producing the E-mail message 58, the E-mail message transmission process 56 initiates the transmission of the E-mail message to the selected opponent of the game instance. In this particular example, the player 18 located at player site 14 selected the player 20 located at player site 16 as an opponent. Typically, to direct the transmission of the E-mail message 58, the E-mail message transmission process 56 retrieves the E-mail address associated with the selected opponent from the HTTP file 48 or from the server site 12. For example, if the E-mail game instance was previously initiated, the E-mail address may be retrieved from the E-mail game instance database 54 that stores each underway game instance.

Other information may also be inserted into the E-mail message 58. For example, an invitation may be included in the E-mail message 58 if the other player 20 has not yet agreed to enter the initiated E-mail game instance. Additionally, the text message from player 18, which was included in the HTTP file 48, may be inserted into the E-mail message 58, for example, to encourage the player 20 to enter the game. Also, information collected from other locations or produced at the server site 12 may be included in the E-mail message 58. For example, advertisements, messages announcing the availability of new E-mail game titles from the server site 12, or other information that may be of interest to the E-mail message recipient may be included in the E-mail message 58. After including the invitation, the current state of the E-mail game instance, advertisements, and other similar information of interest in the E-mail message 58, the message is transmitted to the recipient. In this particular example, the E-mail message 58 is transmitted to the player 20 located at player site 16. However, in some embodiments, the E-mail message may be directed to multiple parties besides the player 20. For example, each time a game move is made by either of the players 18, 20, an E-mail message may be sent to a person or group of people that are tracking the game instance as spectators.

In this particular embodiment, the server 30 uses a simple mail transfer protocol (SMTP) to transmit the E-mail message 58 through the Internet 28 and to a gateway server 60 that is in communication with the player site 16. However, in some embodiments the server 30 uses a protocol such as post office protocol (POP), Internet message access protocol (IMAP), or other similar protocol so that the E-mail message is queued in an appropriate server mailbox that resides on the gateway server 60. Typically, an E-mail process 62 (e.g., Microsoft Outlook™, Eudora™, etc.) executing on a computer system 64 located at the player site 16 accesses the server mailbox assigned to the player 20 and retrieves the E-mail message 58 along with other E-mail messages sent to the player 20.

In this particular embodiment the computer system 64 has previously downloaded a copy of the E-mail game player process 40b that is also present at player site 14 (i.e., E-mail game player process 40a) along with a copy of the E-mail game 34 that is stored on a storage device 66. However, in some embodiments, the E-mail game player process 40b is not present at the player site 16 when the E-mail message 58 is received. In such a scenario, typically the E-mail message 58 includes an invitation for the player 20 to download the E-mail game player process 40b from the server site 12 so that the player can become an opponent in an E-mail game instance. Additionally, once the E-mail game player process 40b is downloaded, or loaded onto the computer system 64 from a durable media (e.g., a floppy diskette, CD-ROM, etc.), the E-mail game player process 40b is stored on the storage device 66 (e.g., hard drive, CD-ROM, etc.) that is in communication with the computer system 64 to provide a backup copy of the process that can be retrieved after an emergency such as accidentally removing of the process from the computer system.

After retrieving the E-mail message 58 from the gateway server 60, the message is displayed by the E-mail process 62 to alert the player 20 that the player 18 at player site 14 has made a game move to the game instance. In some embodiments, if the player 20 selects the E-mail message 58 from the E-mail process 62, to examine the player 18 game move, data included in the E-mail message 58 representing the current state of the E-mail instance is sent to the E-mail game player process 40b and a graphical user interface, such as the GUI 70 shown in FIG. 2, is displayed on the screen of the computer system 64. Additionally, any message from the player 18 is displayed in the GUI 70 along with any advertisement or other similar information included in the E-mail message 58. By allowing the player 20 to view and select the E-mail message 58 to initiate the displaying of the GUI 70 with the current state of the E-mail game instance, the player 20 determines when to view the latest game move made by the player 18. For example, the player 20 can decide to view the latest game move immediately upon becoming aware that the E-mail message 58 has arrived in the E-mail process 62. Or, in another example, the player 20 can decide to view the latest move during a time period when he or she will have sufficient time to study game move by the player 18 (e.g., during a lunch break, at the end of the work day, etc.)

In this particular embodiment, upon the selection of the E-mail message 58 by the player 20 from the E-mail process 62, the GUI 70 is displayed by the E-mail game player process 40b. However, in some embodiments, the E-mail game player process 40b monitors the E-mail process 62 for the receipt of E-mail messages containing a game move. Upon detecting the receipt of such an E-mail message by the E-mail process 62, the E-mail game player process 40b removes the E-mail message from the E-mail process 62 and alerts the player 20 (e.g., with an audible tone issued from a speaker included in the computer system, or a visual signal such as displaying the GUI 70 on the screen of the computer system 64, or a combination of both, etc.) that a game move has been received that is associated with a game instance in which the player 20 is a participant or a potential participant. Once alerted, the player 20 can select to view the GUI 70 and study to game move from the opponent player 18.

In this embodiment, the E-mail message 58 includes a game move along with other information such as one or more advertisements. However, in other embodiments the E-mail message 58 indicates to the player 20 that a game move has been made and the server site 12 is ready to send an HTTP file to the player site 16 that includes the game move. For example, when the player 20 selects the E-mail message 58 from the E-mail process 62, the E-mail game player process 40b is executed by the computer system 64 and an HTTP file is received from the server site 12. Similar to the content of the E-mail message 58, as mentioned above, the HTTP file sent from the server site 12 may include information such as a game move, an invitation to join an E-mail game instance, one or more advertisements, or other similar information. Upon receiving the HTTP file, the E-mail game player process 40b can display the game move, along with other content of the HTTP file to the player 20. Also, in some embodiments, instead of using E-mail messages to transfer gaming information (e.g., a game move, invitation, advertisements, etc.) or to serve as an indication that the server site 12 is ready to send an HTTP file that includes gaming information, instant messaging (IM) is used to exchange gaming information or to provide an indication that an HTTP file is ready for transfer from the server site. By using IM, the game moves and associated information is exchanged between the server site 12 and the player sites 14, 16 relatively quickly.

While viewing the GUI 70 with the computer system 64, the player 20 can make a game move to counter the game move made by the player 18. By making a countering game move, the E-mail game player process 40b produces an HTTP file (not shown) similar to the HTTP file 48 produced at the player site 14 by the E-mail game player process 40a, however the HTTP file produced by the E-mail game player 40b includes the counter game move. In general, due to the counter game move made by the player 20, the direction of information flow reverses to provide the counter move to the player 18. Typically, the HTTP file containing the counter game move is sent to the server site 12 from the player site 16, the counter game move is applied to the state of the E-mail game instance that is stored at the server site, and an E-mail message is transmitted to the player site 14 to alert the player 18 that a counter move has been made by the player 20. Typically, the computer system 42 located at the player site 14 is also executing an E-mail process, such as the E-mail process 62, so that E-mail messages can be retrieved from the gateway server 46. Also, the HTTP file sent from the E-mail game player process 40b may include a text message from the player 20 to the player 18 with one or more comments that may or may not relate to the message sent from player 18 to the player 20. Typically, the E-mail game instance progresses as each player receives an E-mail message containing the latest game move by the other player and then counters with another game move until the game is completed. However, in some embodiments either player may initiate the transmission of an HTTP file to the server site 12 that includes a request to resign from the E-mail game instance.

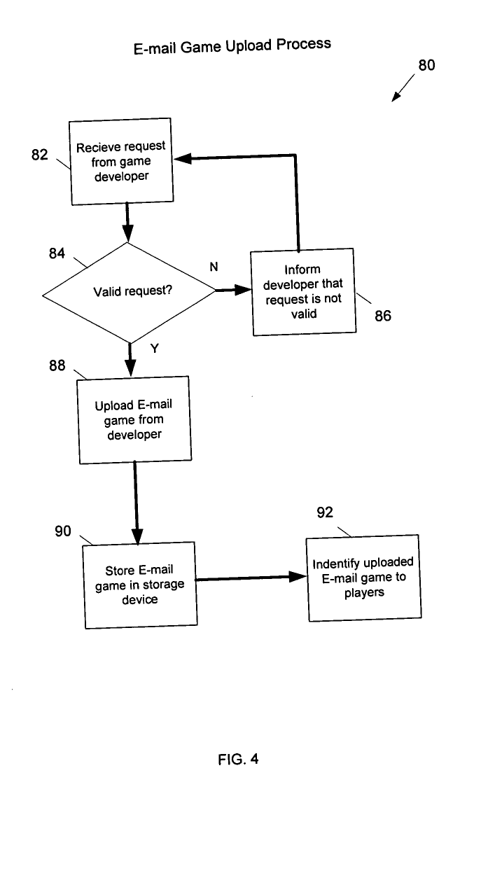

Referring to FIG. 4, an E-mail game upload process 80 or other similar process executed by the server 30 located at the server site 12 includes receiving 82 a request from a E-mail game developer, or other similar entity, for uploading a newly developed E-mail game, an updated E-mail game, or other similar E-mail game. Upon receiving 82 the request, typically the E-mail game upload process 80 determines 84 if the request is valid. In some embodiments, a request is valid if the developer has established a business relationship with the server site 12. For example, if a developer has entered into an agreement with the business entity (e.g., corporation, etc.) that controls the server site 12, a business relationship may be established and the request to upload an E-mail game onto the server site is valid. If determined that the request is not valid, the E-mail game uploading process 80 informs 86 the developer that the request is invalid and may optionally provide information (e.g., contact information for establishing a business relationship) to the developer such that future requests are valid. The E-mail game uploading process 80 then returns to receive 82 another request.

If determined that the request is valid, the E-mail game uploading process 80 uploads 88 the E-mail game from the developer and typically stores 90 the E-mail game in a storage device, such as the storage device 36 to make it available for downloading by potential players. After uploading 88 the E-mail game, the E-mail game upload process 80 identifies 92 the uploaded E-mail game to potential players. For example, a title and brief description of the uploaded E-mail game may be advertised on a website or on a webpage associated with the server site 12. Typically, the title and description of the uploaded E-mail game is provided along with other E-mail games being offered by the server site 12. By providing multiple E-mail games from a single location, the server site 12 provides potential players with a catalog of E-mail game selections without the need for potential players to visit multiple websites to attain the selections. Also, by providing E-mail game developers with the ability to have their E-mail games stored and advertised at the server site 12, relationships may develop between the developers and potential players without the developers needing to self-promote themselves and their products. Typically, to select one or more of the E-mail games advertised by the server site 12 on a website or a webpage, a potential player sends a request to the website associated with the server site 12 that requests one or more selections of interest for downloading. However, the request may also be sent to the server site in an HTTP file from either the E-mail game player processes 40a,b.

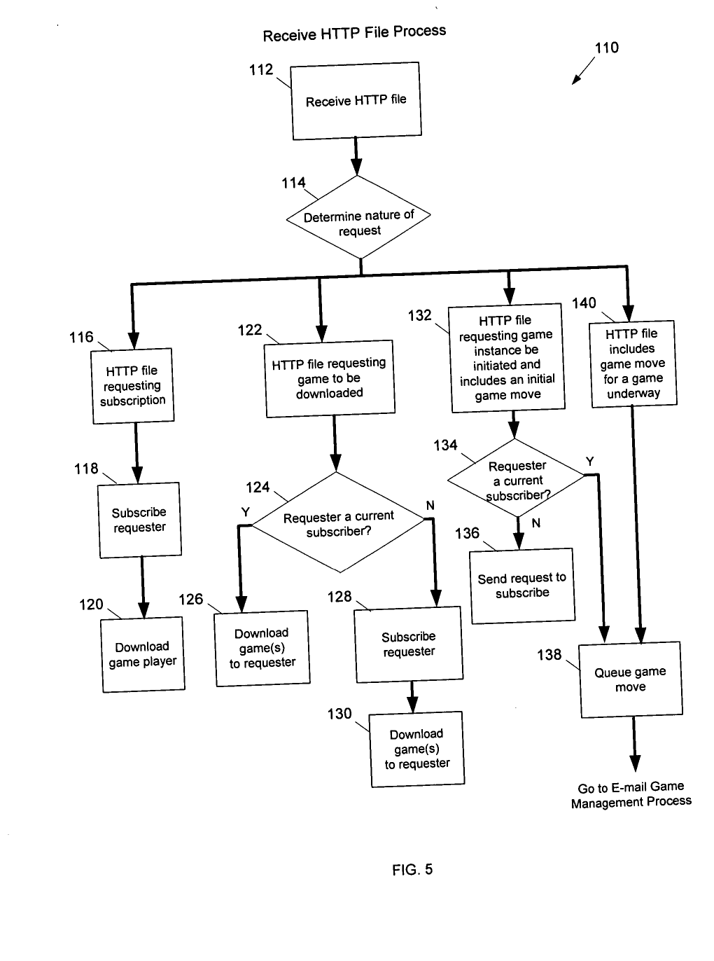

Referring to FIG. 5, a receive HTTP file process 110 or other similar process executed by the server 30 located at the server site 12 includes receiving 112 an HTTP file. Typically, the HTTP file is sent by a player (e.g., player 18) that is interested in initiating an instance of an advertised E-mail game or by a player to provide a game move in a previously initiated game instance. For example, the player 18 may access the server site 12 with the game player process 40a or a web browser and initiate the transmitting of the HTTP file 48 that includes data for initiating an instance of the E-mail game 34 downloaded from the server site 12. The HTTP file may also be transmitted by the player 18 to subscribe to services offered by the server site 12, to download one or more E-mail games offered by the server site, or to provide a game move for a previously initiated instance of an E-mail game that is stored on the server site.

Upon receiving 112 the HTTP file, the receive HTTP file process 110 determines 114 the nature of the request included in the file. For example, the receiving HTTP file process 110 may determine that the HTTP file is requesting 116 to subscribe to the services of the server site 12. Based on this particular request, the receive HTTP file process 110 subscribes 118 the requester to the services, or a portion of the services, available from the server site 12. In some embodiments, to subscribe a requester, the receive HTTP file process 110 queries the requester to provide information typically needed to establish a subscription (e.g., name, billing address, etc.). Typically after the requester is subscribed 118, the receive HTTP file process 110 allows the requester to download 120 a copy of the E-mail game player process 40a to the computer system of the subscriber. However, in some circumstances the subscriber may have already acquired a copy of the E-mail game player process 40a (e.g., by purchasing a CD-ROM storing a copy) and installed the process.

The receive HTTP file process 110 may also determine that the received HTTP file includes information requesting 122 to download one or more games that are stored at the server site 12 in a storage device such as the storage device 36. Upon determining the nature of this particular request, the receive HTTP file process 110 determines 124 if the requester has a current subscription to the appropriate services offered by the server site 12. In some embodiments, to determine if there is a current subscription, the receive HTTP file process 110 accesses a database stored at the server site 12 that contains a list of all current subscribers. If determined that the requester is a current subscriber, the receive HTTP file process 110 allows downloading 126 of the one or more E-mail games stored at the server site that were selected by the requester. If determined that the requester does not have a current subscription, the receive HTTP file process 110 subscribes 128 the requester, if desired by the requester, and then allows downloading 130 of the one or more E-mail games selected by the requester.

If determined that the received HTTP file includes information requesting 132 to initiate an instance of an E-mail game downloaded from the server site 12, the receive HTTP file process 110 determines 134 if the requester is a current subscriber of the server site. If determined that the requester is not a subscriber, for example by checking a subscriber database stored at the server site 12, the receive HTTP file process sends 136 a request that the requester subscribe to the server site. Typically, when requesting to initiate an E-mail game instance, the received HTTP file also includes an initial game move from the player (e.g., player 18) requesting the initiation of the E-mail game instance.

If determined that the requester is a current subscriber of the server site 12, the game move included in HTTP file is stored 138 in a queue until the E-mail game management process 52 is ready to process the game move. In some embodiments to queue the game move, data representing the game move is stored in a memory included in the server 30 and/or on a storage device such as the storage device 36 located at the server site 12. Also, if determined that the received HTTP file includes a game move of an E-mail game instance currently underway, the receive HTTP file process 110 stores 138 the game move in the queue until the E-mail game management process 52 has sufficient time to process to the game move.

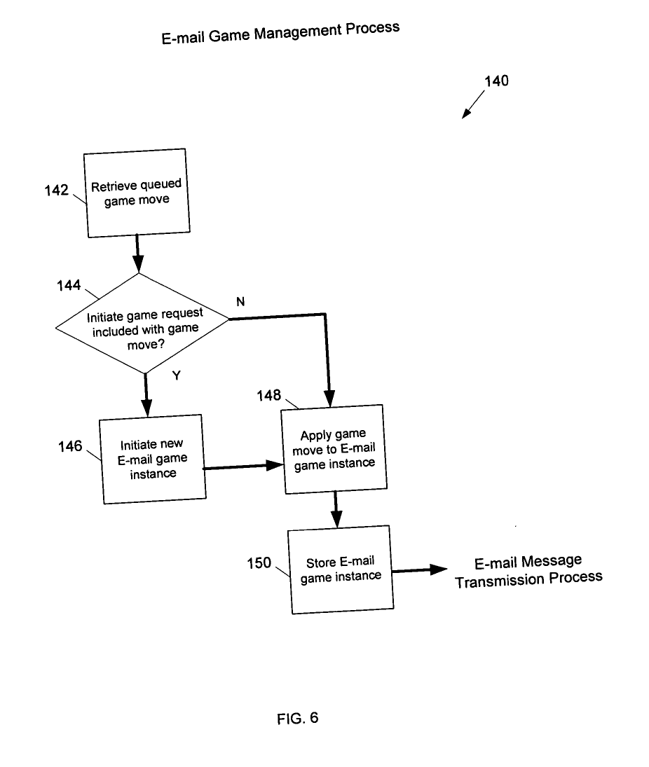

Referring to FIG. 6, an E-mail game management process 140 or other similar process executed by the server 30 located at the server site 12 includes retrieving 142 a queued game move stored at the server site. As mentioned above, in some embodiments game moves are queued in memory and/or in a storage device after the HTTP file that includes the game move is received at the server site 12. By queuing the game move with other received game moves associated with other on-going instances of the multiple E-mail game titles available from the server site 12, the E-mail game management process 140 is capable of processing a significant volume of game moves without losing one or more game moves. After retrieving 142 the queued game move, the E-mail game management process 140 determines 144 if the retrieved game move is associated with a request to initiate a new instance of an E-mail game title or whether the game move is associated with an E-mail game instance already underway. In some embodiments, the E-mail game management process 140 accesses a database stored at the server site 12 to determine if the retrieved game move is associated with an E-mail game instance underway or if a new E-mail game instance is being requested. Typically, data (e.g., an identification number) included with the retrieved game move identifies if there is an associated E-mail game instance already underway. If determined that the game move is not associated with an E-mail game instance underway and is associated with a request to initiate a new game instance, the E-mail game management process 140 initiates 146 a new E-mail game instance. In some embodiments, initiating a new game instance includes producing data that identifies the game instance, along with the requester, and storing the data in a database such as the E-mail game instance database 54 stored at the server site 12.

If determined that the retrieved game move is associated with a previously initiated game instance, or after initiating 156 a new game instance, the E-mail game management process 140 applies 148 the game move to the associated E-mail game instance. Typically, the game move is applied by updating the state of the game instance to reflect the game move. For example, for a “turn-based” E-mail game (e.g., checkers, chess, etc.), the server site 12 may store the current position of each game piece (e.g., checker piece, chess piece, etc.) as the current state of the game instance. To apply a game move, the E-mail game management process 140 may retrieve the state of the game instance and apply the game move by updating the position of each game piece or just the position of each game piece that has changed position based on the game move. After the game move is applied 148 to the previously initiated game instance or to the newly initiated game instance, the E-mail game management process 140 stores 150 the E-mail game instance at the server site 12. In some embodiments, the E-mail game instance is stored by storing the updated positions of the game pieces in the E-mail game instance database 54 on the storage device 36. By storing the current state of the game instance, the E-mail game management process 150 maintains each game instance so that in the event of a computer system failure or other similar emergency at either player site 14, 16, the state of each game instance is not lost. Typically, after a game move is applied to the appropriate E-mail game instance maintained by the E-mail game management process 140, the updated state of the game instance is sent to a process such as the E-mail message transmission process 56 so that the updated state is included in an E-mail message that is sent to an opponent player (e.g., player 20) to initiate a counter game move.

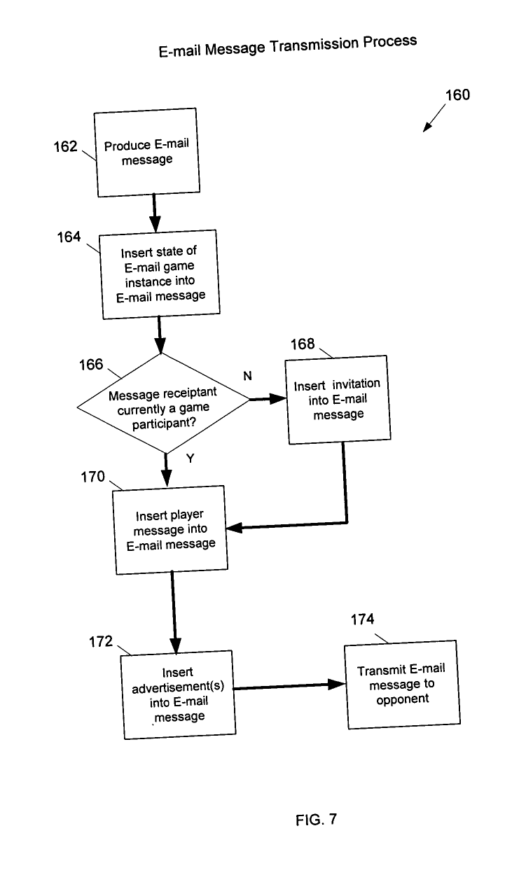

Referring to FIG. 7, an E-mail message transmission process 160 or other similar process executed by the server 30 located at the server site 12 includes producing 162 an E-mail message based on the server site 12 receiving a game move associated with a request to initiate an E-mail game instance or associated with a E-mail game instance currently underway. In some embodiments the E-mail message is produced using simple mail transfer protocol (SMTP), post office protocol (POP), or other similar protocol. In this particular embodiment, the E-mail message includes information to alert the recipient to purpose of the message along with providing the current state of the E-mail game instance. For example, the E-mail message transmission process 160 inserts 164 data into the E-mail message that represents the current state of the E-mail game instance. However, other embodiments, the E-mail message transmission process 160 insert information into the E-mail message to indicate that an HTTP file, that includes the current state of the E-mail game instance, along with other information (e.g., advertisements), is ready to be transmitted from the server site 12. Typically, prior to inserting the data representing the state of the E-mail game instance stored at the server site 12, the state of the E-mail game instance is updated to reflect the received game move.

The E-mail message transmission process 160 also includes determining 166 if the message recipient is a current participant of an E-mail game instance underway, or, if the E-mail game instance has been newly initiated and the message recipient needs an invitation to join the newly initiated game instance. If determined that the E-mail game instance is newly initiated, the E-mail message transmission process 160 inserts 168 an invitation into the E-mail message. Typically, the invitation identifies the person (e.g., player 18) that initiated the E-mail game instance and along with identifying the recipient (e.g., player 20). Also, the invitation typically includes information that identifies how the message recipient can subscribe to the services of the server site 12 and download a copy of the E-mail game player process 40b to join the E-mail game instance. For example, the E-mail message may include data identifying a website or providing a website link associated with the server site 12 so that the message recipient can access the website with a web browser (e.g., Microsoft Explorer™, Netscape Navigator™, etc.) to provide information for a subscription. If determined that the message recipient is a current participant of an E-mail game instance underway, typically an invitation is not included in the E-mail message.

The E-mail message transmission process 160 also includes inserting 170 any message that was included in the HTTP file received from the player (e.g., player 18) that made the most recent game move. By including the message, the recipient of the E-mail message can be encouraged to join the game instance or to make a countering game move and include a message to be delivered to the other player. In some embodiments, the message included in the E-mail message is a text message that is displayed in the E-mail process 62 executing on the computer system 64 at the player site 16. However, in some embodiments the message may include audio and/or video content for presentation on the computer system 64. Furthermore, in other embodiments of the E-mail message transmission process 160, message inserting is optional and the E-mail message may not include any messages.

Additionally, the E-mail message transmission process 160 also includes inserting 172 advertisement material into the E-mail message prior to transmission. For example, one or more advertisements may be inserted into the E-mail message to alert the message recipient that new or updated E-mail games are now available for downloading from the server site 12. The advertisement material may also be collected at the server site 12 from other sources. For example, computer manufactures, other gaming sites, or other similar entities may provide advertisement material to the server site 12 for inclusion in some or all of the E-mail messages transmitted by the E-mail message transmission process 160.

After the E-mail message is produced and the appropriate information inserted (e.g., E-mail game instance state, player messages, advertisements, etc.), the E-mail message transmission process 160 initiates the transmitting 174 of the E-mail message to the message recipient. Referring back to FIG. 1, in this particular embodiment, the E-mail message 58 is sent from server 30 through the Internet 28, and received by the gateway computer system 60 and is placed into an E-mail depository. The E-mail process 62 executing on the computer system 64 included at the player site 16 retrieves the E-mail message 58 and presents the E-mail message to the player 20. When the player 20 is ready to view the most recent game move made by the other player (i.e., player 18), the E-mail message 58 is selected by the player 20 and the E-mail game player process 40b accesses the E-mail message to retrieve the included information. The E-mail game player process 40b then presents the current state of the E-mail game instance to the player 20 in a graphical user interface such as the GUI 70 shown in FIG. 2. After studying the current state of the E-mail game instance, the player 20 can decide to make a countering game move at the current time or to wait for a later time. Upon making a countering game move, the E-mail game player process 40b produces an HTTP file that includes the countering game move along with other information, such as a message from the player 20 to the opponent player 18. Similar to the HTTP file 48, the HTTP file including the countering game move is sent from the player site 16 to the server site 12 and in a similar fashion an E-mail message is sent to the player site 14 to alert the player 18 to the counter game move.

A number of embodiments of the invention have been described. Nevertheless, it will be understood that various modifications may be made without departing from the spirit and scope of the invention. For example, hardwire technology (e.g., cable line, twisted pair conductors, etc.), wireless technology (e.g., electromagnetic (EM), infrared (IR), optical, etc.), or a combination of hardwire and wireless technology may be used to provide communication links between the server site 12 and the player sites 14, 16 with or without communicating through the Internet 28. Also, in some embodiments, besides using computers systems 42, 64, other types of digital devices (e.g., personal digital assistants (PDAs), laptop computers, cellular telephones, etc) may be used individually or in combination at either of the player sites 14, 16 for receiving E-mail messages and transmitting HTTP files, or other appropriate files. The server site 12 and the player sites 14, 16 may also incorporate identification encoding along with encryption/decryption techniques and verification techniques to provide secure data transferring of HTTP files and E-mail messages.

The processes described above can be implemented in digital electronic circuitry, or in computer hardware, firmware, software, or in combinations of them. The processes described herein can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Accordingly, other embodiments are within the scope of the following claims.

1. A computer-implemented method for managing distribution of games, the method comprising:
receiving a first E-mail game on a server located at a server site;
storing the received first E-mail game at the server site with a previously stored second E-mail game;
providing access to the first and second E-mail games for retrieval; and
sending the first E-mail game, if requested by a first player, to a first game player site for initiating an instance of the first E-mail game.

2. The computer-implemented method of claim 1 further comprises:
receiving a file on the server from the first game player site, the file including data representing a first game move associated with an initiated instance of the first E-mail game;
producing an E-mail message that includes data representing the first game move applied to the initiated instance of the first E-mail game; and
transmitting the E-mail message to a second game player site to initiate a second game move of the initiated instance of the first E-mail game by a second player.

3. The computer-implemented method of claim 1, wherein the first E-mail game is received from an E-mail game developer site.

4. The computer-implemented method of claim 1, wherein the first and second E-mail games are stored on a storage device storing multiple E-mail games.

5. The computer-implemented method of claim 2, wherein the file uses hypertext transfer protocol (HTTP).

6. The computer-implemented method of claim 2, wherein the file includes extensible markup language (XML).

7. The computer-implemented method of claim 2, wherein the file includes a message from the first player for delivery to the second player.

8. The computer-implemented method of claim 2, wherein the file identifies the second player.

9. The computer-implemented method of claim 2, further comprising:
storing the first game move applied to the initiated instance of the first E-mail game on a storage device in communication with the server.

10. The computer-implemented method of claim 2, wherein the E-mail message includes an invitation for the second player to participate in the initiated instance of the first E-mail game.

11. The computer-implemented method of claim 2, wherein the E-mail message includes an advertisement for displaying to the second player.

12. The computer-implemented method of claim 2, wherein the E-mail message includes the state of the initiated instance of the first E-mail game.

13. The computer-implemented method of claim 2, wherein the first E-mail game is a turn-based E-mail game.

14. The computer-implemented method of claim 2, wherein the first game move applied to the initiated instance of the first E-mail game is displayed at the second game player site based on receipt of the E-mail message.

15. The computer-implemented method of claim 1 further comprises:
receiving a file on the server from the first game player site, the file including data representing a first game move associated with an initiated instance of the first E-mail game;
producing an E-mail message that includes data representing the server being ready to transmit an HTTP file that includes data representing the first game move applied to the initiated instance of the first E-mail game; and
transmitting the E-mail message to a second game player site to initiate a second game move of the initiated instance of the first E-mail game by a second player.

16. A computer program product, tangibly embodied in an information carrier, for managing distribution of games on a computer, the computer program product being operable to cause a machine to:
receive a first E-mail game file on a server at a server site;
store the received first E-mail game at the server site with a previously stored second E-mail game file;
provide access to the first and second E-mail games file for retrieval; and
send the first E-mail game, if requested by a first player, to a first game player site for initiating an instance of the first E-mail game.

17. The computer program product of claim 16, being further operable to cause a machine to:
receive a file on the server from the first game player site, the file including data representing a first game move associated with an initiated instance of the first E-mail game;
produce an E-mail message that includes data representing the first game move applied to the initiated instance of the first E-mail game; and
transmit the E-mail message to a second game player site to initiate a second game move of the initiated instance of the first E-mail game by a second player.

18. The computer program product of claim 16, wherein the first E-mail game is received from an E-mail developer site.

19. The computer program product of claim 16, wherein the first and second E-mail games are stored on a storage device storing multiple E-mail games.

20. The computer program product of claim 17, wherein the data file uses hypertext transfer protocol (HTTP).

21. The computer program product of claim 17, wherein the data file includes extensible markup language (XML).

22. The computer program product of claim 17, wherein the file includes a message from the first player for delivery to the second player.

23. The computer program product of claim 17, wherein the file identifies the second player.

24. The computer program product of claim 17, being further operable to cause a machine to:
store the first game move applied to the initiated instance of the first E-mail game on a storage device in communication with the server.

25. The computer program product of claim 17, wherein the E-mail message includes an invitation for the second player to participate in the initiated instance of the first E-mail game.

26. The computer program product of claim 17, wherein the E-mail message includes an advertisement for displaying to the second player.

27. The computer program product of claim 17, wherein the E-mail message includes the state of the initiated instance of the first E-mail game.

28. The computer program product of claim 17, wherein the first E-mail game is a turn-based E-mail game.

29. The computer program product of claim 17, wherein the first game move applied to the initiated instance of the first E-mail game is displayed at the second game player site based on the receipt of the E-mail message.

30. The computer program product of claim 16, being further operable to cause a machine to:
receive a file on the server from the first game player site, the file including data representing a first game move associated with an initiated instance of the first E-mail game;
produce an E-mail message that includes data representing the server being ready to transmit an HTTP file that includes data representing the first game move applied to the initiated instance of the first E-mail game; and
transmit the E-mail message to a second game player site to initiate a second game move of the initiated instance of the first E-mail game by a second player.

31. A process for managing distribution of games comprises:
a process to receive a first E-mail game on a server located at a server site;
a process to store the received first E-mail game at the server site with a previously stored second E-mail game; and
a process to provide access to the first and second E-mail game file for retrieval; and
a process to send the first E-mail game, if requested by a first player, to a first game site for initiating an instance of the first E-mail game.

32. The process of claim 31 further comprises:
a process to receive a file on the server from the first game player site, the file including data representing a first game move associated with an initiated instance of the first E-mail game;
a process to produce an E-mail message that includes data representing the first game move applied to the initiated instance of the first E-mail game; and
a process to transmit the E-mail message to a second game player site to initiate a second game move of the initiated instance of the first E-mail by a second player.

33. The process of claim 31, wherein the first E-mail game is received from an E-mail game developer site.

34. The process of claim 32, wherein the first and second E-mail games are stored on a storage device storing multiple E-mail games.

35. The process of claim 32, wherein the file uses hypertext transfer protocol (HTTP).

36. The process of claim 32, wherein the file includes extensible markup language (XML).

37. The process of claim 32, wherein the file includes a message from the first player for delivery to the second player.

38. The process of claim 32, wherein the file identifies the second player.

39. The process of claim 32 further comprising:
a process to store the first game move applied to the initiated instance of the first E-mail game on a storage device in communication with the server.

40. The process of claim 32, wherein the E-mail message includes an invitation for the second player to participate in the initiated instance of the first E-mail game.

41. The process of claim 32, wherein the E-mail message includes an advertisement for displaying to the second player.

42. The process of claim 32, wherein the E-mail message includes the state of the initiated instance of the first E-mail game.

43. The process of claim 32, wherein the first E-mail game is a turn-based E-mail game.

44. The process of claim 32, wherein the first game move applied to the initiated instance of the first E-mail game is displayed at the second game player site based on the receipt of the E-mail message.

45. The process of claim 31 further comprises:
a process to receive a file on the server from the first game player site, the file including data representing a first game move associated with an initiated instance of the first E-mail game;
a process to produce an E-mail message that includes data representing the server being ready to transmit an HTTP file that includes data representing the first game move applied to the initiated instance of the first E-mail game; and
a process to transmit the E-mail message to a second game player site to initiate a second game move of the initiated instance of the first E-mail by a second player.

46. A game distribution system comprising:
a server capable of,
receiving a first E-mail game at a server site,
storing the received first E-mail game at the server site with a previously stored second E-mail game,
providing access to the first and second E-mail games for retrieval, and
sending the first E-mail game, if requested by a first player, to a first game player site for initiating an instance of the first E-mail game.

47. The game distribution system of claim 46, wherein the server is further capable of:
receiving a file from the first game player site, the file including data representing a first game move associated with an initiated instance of the first E-mail game;
producing an E-mail message that includes data representing the first game move applied to the initiated instance of the first E-mail game; and
transmitting the E-mail message to a second game player site to initiate a second game move of the initiated instance of the first E-mail game by a second player.

48. The system of claim 46, wherein the first E-mail game is received from an E-mail game developer site.

49. The game distribution system of claim 46, wherein the server is further capable of:
receiving a file from the first game player site, the file including data representing a first game move associated with an initiated instance of the first E-mail game;
producing an E-mail message that includes data representing the server being ready to transmit an HTTP file that includes data representing the first game move applied to the initiated instance of the first E-mail game; and
transmitting the E-mail message to a second game player site to initiate a second game move of the initiated instance of the first E-mail game by a second player.

50. A game distribution system comprising:
a first game player site capable of,
receiving an E-mail message from a server site, the E-mail message associated with a first game move applied to an initiated instance of an E-mail game;
producing a file that includes data representing a second game move applied to the initiated instance of the E-mail game; and
transmitting the file to the server site to initiate a next game move of the initiated instance of the first E-mail game.

51. The game distribution system of claim 50, wherein the E-mail message includes data representing the first game move applied to the initiated instance of the E-mail game.

52. The game distribution system of claim 50, wherein the E-mail message includes data representing the server being ready to transmit an HTTP file that includes data representing the first game move applied to the initiated instance of the first E-mail game.
